(19) United States
(12) Patent Application Publication
(10) Pub. No.: US 2008/0102170 A1
(43) Pub. Date: May 1, 2008

(54) Aqueous Dispersion and its Use for the Anti-Mould Treatment of Rinded Cheeses

(75) Inventor: Vittorio Capra, Torino (IT)

Correspondence Address: Edward D. Manzo, Esq.;COOK, ALEX, MCFARRON, MANZO,, CUMMINGS & MEHLER, Ltd., 200 West Adams Street, Suite 2850, Chicago, IL, 60606, US

(73) Assignee: Lidi Polimeri S.r.l.

(21) Appl. No.: 11/676,787

(22) Filed: Feb. 20, 2007

(30) Foreign Application Priority Data
Oct. 30, 2006 (EP) 06425746.2

(51) Int. Cl. A23C 19/097; A23C 19/16; A23G 3/00

(52) U.S. Cl. 426/90; 426/310; 426/582

(57) ABSTRACT

The aqueous dispersion comprises, with reference to 100 parts of water, from 1 to 150 parts of a polymer the monomeric units of which are selected from the group consisting of ethylene, vinyl and acrylic esters of saturated fatty acids having from 2 to 16 carbon atoms, vinyl versatate, and maleic and formic acid esters of saturated alcohols having from 4 to 8 carbon atoms, and from 0.01 to 5 parts of an ion-exchange zeolite containing silver and/or copper ions.

The dispersion is intended for the treatment of rinded cheeses so as to form a coating film containing the above-indicated polymer and zeolite.

The present invention relates to the field of the treatment of rinded cheeses and, in particular, to the prevention of the formation of moulds on their surface.

In this connection it is known to treat such cheeses with aqueous solutions containing organic active ingredients, in particular of the antibiotic type such as, for example, pimaricin E235, or sorbic acid. However, once these organic active ingredients have been applied to the surface of a cheese, they tend to migrate to its interior, adversely affecting the organoleptic properties of the cheese and giving rise to possible risks to the consumer.

The object of the present invention is to overcome the above-mentioned problems of the prior art.

This object is achieved by virtue of an aqueous dispersion for the treatment of rinded cheeses comprising, with reference to 100 parts of water:

from 1 to 150 parts of at least one polymer the monomeric units of which are selected from the group consisting of ethylene, vinyl and acrylic esters of saturated fatty acids having from 2 to 16 carbon atoms, vinyl versatate, and maleic and formic acid esters of saturated alcohols having from 4 to 8 carbon atoms, and

from 0.01 to 5 parts of an ion-exchange zeolite containing silver and/or copper ions.

The polymer will thus be a homopolymer when all of the monomeric units on the basis of which the polymerization reaction is performed are identical, or a copolymer when the monomeric units are of two or more different types.

A further subject of the present invention is a process for the treatment of a rinded cheese, comprising a step consisting of the formation of a film coating of the cheese with the use of a dispersion of the above-mentioned type.

Yet another subject of the present invention is a rinded cheese coated with a film comprising a polymer the monomeric units of which are selected from the group consisting of ethylene, vinyl and acrylic esters of saturated fatty acids having from 2 to 16 carbon atoms, vinyl versatate, and maleic and formic acid esters of saturated alcohols having from 4 to 8 carbon atoms, and an ion-exchange zeolite containing silver and/or copper ions, the coated cheese being obtainable as a result of the implementation of the above-described method.

The active ingredient of the dispersions of the invention, which prevents the formation of moulds in particular, is constituted by the silver and/or copper ions which do not tend to migrate into the cheeses treated, thus avoiding the problems resulting from the use of the organic active ingredients of the prior art. Moreover, this advantageous property of the active ingredient of the invention exempts the producer and/or marketer of the cheese thus treated from the obligation to declare its presence on the label.

The dispersion preferably contains from 6 to 100 parts of the polymer and from 0.1 to 2 parts of the zeolite, with reference to 100 parts of water. The polymer may be used in the form of a dispersion in water or in polar solvents in general. The zeolite, for its part, preferably contains from 0.3 to 3% by weight of silver and/or copper ions.

As already indicated, the dispersion of the invention is used in the step consisting of the formation of a film coating of a rinded cheese which takes place in the course of a cheese treatment process. In principle, the methods of implementing the film-forming step are not subject to any particular limitations.

For example, the cheese may be immersed in the dispersion for a period of between 1 and 5 seconds, the dispersion being kept at a temperature of between 10 and 25° C. Alternatively, the dispersion may be applied to the surface of the cheese by means of brushes, felt pads, or similar tools.

The step consisting of the formation of the coating film typically terminates with a period of drying of the water that was initially present in the dispersion. A step consisting of maturation of the coated cheese advantageously takes place after the step consisting of the formation of the coating film. The maturation step usually has a duration of between 10 and 365 days and takes place at a temperature of between 2 and 7° C. and with a relative humidity of between 80 and 90%. If necessary, the step of immersion in or application of the dispersion and the subsequent drying may also be repeated several times in the course of the maturation step.

Upon completion of the treatment process of the invention, the cheese has conventional organoleptic properties and, moreover, has no surface mould. The anti-mould properties also persist during the subsequent storage period by virtue of the fact that the antibacterial activity of the silver and/or copper ions incorporated in the coating film remain unchanged for long periods of time.

Further advantages and characteristics of the present invention will become clear from the following examples of the composition of a dispersion and of the methods for the use thereof, which are provided by way of non-limiting example. All of the percentages mentioned should be understood as percentages by weight unless indicated otherwise.

### EXAMPLE 1

A dispersion was formed by mixing the following ingredients in the percentages by weight indicated:

| | |
|---|---|
| Vinavil ® CF5 (aqueous dispersion of vinyl acetate and butyl | 10%, |
| maleate having a 50% solids content) | |
| Agion ® AJ 10D (zeolite containing 2.5% of silver ions) | 1%, |
| water | 89%. |

The dispersion was used to form a bath which was kept at ambient temperature. A Provolone cheese which, after production, had been dried until the rind had adopted a straw-yellow colour, was immersed in the bath for a period of 2-3 seconds.

After immersion in the bath, the cheese was dried and then subjected to maturation for about 30 days in a well-aerated cell kept at a temperature of between 2 and 7° C. Upon completion of the maturation, the cheese had a coating film which rendered it free of mould as well as of superficial bacterial loads and viruses.

### EXAMPLE 2

A dispersion was formed by mixing the following ingredients in the percentages by weight indicated:

| | |
|---|---|
| Vinavil ® CF5 (aqueous dispersion of vinyl acetate and butyl | 94.8%, |
| maleate having a 50% solids content) | |
| Agion ® AJ 10D (zeolite containing 2.5% of silver ions) | 0.2%, |
| water | 5%. |

The dispersion was applied by means of a brush at ambient temperature to a Caciotta cheese which, after production, had been dried until the rind had adopted a straw-yellow colour.

After this treatment, the cheese was dried and then subjected to maturation for a period of about 12 months at a temperature of between 2 and 7° C. The application of the dispersion may be repeated several times during the first months of maturation.

Upon completion of the maturation, the cheese had a coating film which rendered it free of mould as well as of superficial bacterial loads and viruses.

Naturally, the principle of the invention remaining the same, the details of implementation and forms of embodiment may be varied widely with respect to those described purely by way of example without thereby departing from the scope claimed. In particular, a dispersion of the invention may comprise, in addition to the ingredients specified above, also organic ingredients such as, for example, pimaricin E235 and/or sorbic acid which would in any case be present in smaller quantities than those provided for by the prior art, with a corresponding reduction in the adverse effects typically associated therewith. If necessary, the dispersion of the invention may also comprise desired conventional additives, for example, colorants.

What is claimed is:

1. An aqueous dispersion for the treatment of rinded cheeses, comprising, with reference to 100 parts of water:
from 1 to 150 parts of a polymer the monomeric units of which are selected from the group consisting of ethylene, vinyl and acrylic esters of saturated fatty acids having from 2 to 16 carbon atoms, vinyl versatate, and maleic and formic acid esters of saturated alcohols having from 4 to 8 carbon atoms, and
from 0.01 to 5 parts of an ion-exchange zeolite containing silver and/or copper ions.

2. A dispersion according to claim 1, containing from 6 to 100 parts of the polymer.

3. A dispersion according to any one of the preceding claims, containing from 0.1 to 2 parts of the zeolite.

4. A dispersion according to claim 1 in which the zeolite contains from 0.3 to 3% by weight of silver ions.

5. A process for the treatment of a rinded cheese which comprises a step consisting of the formation of a film coating of the cheese with the use of a dispersion according to any one of the preceding claims, the film comprising a polymer and an ion-exchange zeolite containing silver and/or copper ions.

6. A process according to claim 5 in which the rinded cheese is immersed in the dispersion.

7. A process according to claim 6 in which the rinded cheese is immersed in the dispersion for a period of between 1 and 5 seconds.

8. A process according to claim 6 in which the dispersion is kept at a temperature of between 10 and 25° C.

9. A process according to claim 6 in which the dispersion is applied to the surface of the rinded cheese.

10. A process according to any one of claims 5 to 9 in which the step consisting of the formation of the coating film concludes with a drying period and in which, after the formation step, a step consisting of maturation of the cheese takes place.

11. A process according to claim 10 in which the maturation step has a duration of between 10 and 365 days.

12. A process according to claim 10 in which the maturation step is performed at a temperature of between 2 and 7° C.

13. A rinded cheese, coated with a film comprising a polymer the monomeric units of which are selected from the group consisting of ethylene, vinyl and acrylic esters of saturated fatty acids having from 2 to 16 carbon atoms, vinyl versatate, and maleic and formic acid esters of saturated alcohols having from 4 to 8 carbon atoms, and an ion-exchange zeolite containing silver and/or copper ions, the coated cheese being obtainable as a result of the implementation of the process of any one of preceding claims 5 to 12.
